(19) United States
(12) Patent Application Publication
(10) Pub. No.: US 2015/0308619 A1
(43) Pub. Date: Oct. 29, 2015

(54) CLADDED PRESSURE TANK AND METHOD OF PREPARATION

(71) Applicant: BLUE WAVE CO S.A., Luxembourg (LU)

(72) Inventors: Francesco NETTIS, London (GB); Vanni Neri TOMASELLI, Luxembourg (LU)

(21) Appl. No.: 14/649,504

(22) PCT Filed: Dec. 5, 2012
(86) PCT No.: PCT/EP2012/074559

§ 371 Date: Jun. 3, 2015

(51) Int. Cl. F17C 1/00; C23C 30/00; C23C 26/02; B23K 26/34; B23K 31/02

(52) U.S. Cl. CPC F17C 1/00; B23K 26/34; B23K 31/02; C23C 26/02; C23C 30/005

(57) ABSTRACT

A method of producing a pressure vessel, and the corresponding pressure vessel, wherein the pressure vessel is comprised of different types of structural elements, one of the structural elements being comprised of a metal substrate having a liner material adhering to the substrate in adjoining linear areas; and orientated so that adjoining linear areas of lining material are orientated longitudinally with respect to a completed pressure vessel.

### FIELD OF THE INVENTION

The present invention relates to cladded pressure tanks and a method of preparing a pressure tank. In particular, embodiments of the invention relate to a cladded pressure tank suitable for the storage and transport of compressed natural gas (CNG) and a method of preparing a pressure tank for CNG storage and transport.

### BACKGROUND ART

CNG can include various potential component parts in a variable mixture of ratios, some in their gas phase and others in a liquid phase, or a mixture of both. Those component parts will typically comprise one or more of the following compounds: C₂H₆, C₃H₈, C₄H₁₀, C₅H₁₂, C₆H₁₄, C₇H₁₆, C₈H₁₈, C₉+ hydrocarbons, CO₂ and H₂S, plus potentially toluene, diesel and octane in a liquid state. Many of these components can have a corrosive effect on any container used to store or transport CNG.

However, stainless steel can be highly resistant to salt-water corrosion, and likewise chemical attack, even from many or all of the aggressive agents that would typically be present in the stored CNG—necessary since it is frequently the case that the CNG will be raw or untreated. However, stainless steel is expensive to manufacture and has lower mechanical properties that would lead to excessive thicknesses and weights in comparison with non-corrosion proof carbon steel alloys or similar solutions.

The danger of corrosion and degradation of the internal surface of raw gas and CNG containers is known. Some metal pressure vessels are provided with a protective layer on the inside surface of the vessel. That layer can be created using specific technologies such as, for example, painting, thermal vitrification or plasma deposits. However, with all of these methods it is difficult to achieve a protective layer having a uniform thickness together with a cost-effective manufacturing technique. A non-uniform coating thickness could lead to greater damage to the structural metal: thinner coating areas may expose the metal surface sooner than thicker areas; if this happens, since the current density of corrosive phenomena is usually constant, the damage may concentrate on the exposed areas rather than on the entire metal surface provoking a non-uniform corrosion and therefore a greater reduction in the thickness of the metal.

Other known solutions relate to multi-layer non-metal containers, made of composite materials, where the first internal layer in contact with the gas is created using impermeable polymer materials which are potentially degradable in the long term.

Furthermore, the process of cladding, whereby two different metals are joined, is a known process for treating or repairing metal objects. One known form of cladding involves joining a liner material to a substrate material and providing an adhesion between the two. Traditionally, the liner material has been joined to the substrate by arc welding or the use of oxy acetylene torches. A more recent development for cladding involves providing the liner material (often a metal) in powder form and then, at the site of the desired cladding, melting the powder with the use of a laser or other high-power, easily focused energy source to melt the powder and thereby provide a liner. Sequential passes of the energy source allow surfaces of many different types and shapes to be treated in this manner. Such methods of cladding are referred to as ‘laser cladding’.

CNG loading and offloading procedures and facilities depend on several factors linked to the locations of gas sources and the composition of the gas concerned.

With respect to facilities for connecting to ships (buoys, platform, jetty, etc. . . . ) it is desirable to increase flexibility and minimize infrastructure costs. Typically, the selection of which facility to use is made taking the following criteria into consideration:
safety;
reliability and regularity;
bathymetric characteristics water depth and movement characteristics; and
ship operation: proximity and manoeuvring.

A typical platform comprises an infrastructure for collecting the gas which is connected with the seabed.

A jetty is another typical solution for connecting to ships (loading or offloading) which finds application when the gas source is onshore. From a treatment plant, where gas is treated and compressed to suitable loading pressure as CNG, a gas pipeline extends to the jetty and is used for loading and offloading operations. A mechanical arm extends from the jetty to a ship.

Jetties are a relatively well-established solution. However, building a new jetty is expensive and time-intensive. Jetties also require a significant amount of space and have a relatively high environmental impact, specifically in protected areas and for marine traffic.

Solutions utilizing buoys can be categorized as follows:
CALM buoy;
STL system;
SLS system; and
SAL system.

The Catenary Anchor Leg Mooring (CALM) buoy is particularly suitable for shallow water. The system is based on having the ship moor to a buoy floating on the surface of the water. The main components of the system are: a buoy with an integrated turret, a swivel, piping, utilities, one or more hoses, hawsers for connecting to the ship, a mooring system including chains and anchors connecting to the seabed. The system also comprises a flexible riser connected to the seabed. This type of buoy requires the support of an auxiliary/service vessel for connecting the hawser and piping to the ship.

The Submerged Turret Loading System (STL) comprises a connection and disconnection device for rough sea conditions. The system is based on a floating buoy moored to the seabed (the buoy will float in an equilibrium position below the sea surface ready for the connection). When connecting to a ship, the buoy is pulled up and secured to a mating cone inside the ship. The connection allows free rotation of the ship hull around the buoy turret. The system also comprises a flexible riser connected to the seabed, but requires dedicated spaces inside the ship to allow the connection.

The Submerged Loading System (SLS) consists of a seabed mounted swivel system connected to a loading/offloading riser and acoustic transponders. The connection of the floating hose can be performed easily without a support vessel. By means of a pick up rope the flexible riser can be lifted and then connected to a corresponding connector on the ship.

The Single Anchor Loading (SAL) comprises a mooring and a fluid swivel with a single mooring line, a flexible riser for fluid transfer and a single anchor for anchoring to the seabed. A tanker is connected to the system by pulling the mooring line and the riser together from the seabed and up towards the vessel. Then the mooring line is secured and the riser is connected to the vessel.

### Technical Problem to be Solved

When laser cladding is applied to such vessels, the resulting lining tends to be porous which can be susceptible to corrosion. Furthermore, cladding may result in areas with varying elastic properties. Therefore, any subsequent deformation of the material can result in cracks developing.

Cladding, and in particular laser cladding, suffers from a number of disadvantages when applied to enclosed cylindrical structures such as pressure vessels. One such difficulty lies in applying the cladding to an existing pressure vessel; the diameter of such vessels is too small to house the apparatus needed for more traditional cladding methods.

It is an object of the invention to provide for an improved method of manufacturing a vessel such as a pressure vessel having cladded structural elements.

It is a further object of the invention to provide for a method of laser cladding which may be reliably applied to repurpose existing pressure vessels for the storage and transport of CNG.

### SUMMARY OF THE INVENTION

A first aspect of the invention relates to a method of producing a pressure vessel, the method comprising:
providing a metal substrate having an outer surface and an inner surface;
producing one or more structural elements of a first type for the pressure vessel by adhering a liner material to said substrate;
joining a plurality of structural elements to form said pressure vessel, wherein:
said step of producing said structural elements of the first type includes adhering the liner material to the inner surface of the substrate in adjoining linear areas; and
said step of joining the plurality of structural elements includes orientating said structural elements of the first type so that the adjoining linear areas of lining material are orientated longitudinally with respect to a completed pressure vessel.

Structural elements of the first type may be provided as substantially planar members.

The method may include the step of deforming one or more of said structural elements of the first type. The deformation may comprise bending.

Where the structural element of the first type is bent, it may be orientated so that the bending occurs in a direction parallel to the orientation of said adjoining linear areas of liner material. Preferably the bending or deformation will cause the liner material to contract or crimp. This has the advantage of tending to close or reduce any pores in the liner material thereby rendering the resulting lining less susceptible to corrosion. This is particularly useful for the transport of CNG which is corrosive.

The pressure vessel may comprise two head portions attached to either end of a cylindrical portion. In this case, the cylindrical portion may be constructed from one or more structural elements of the first type. Where more than one structural element of the first type is used, all structural elements of the first type for the cylindrical portion may be orientated so that the linear areas of liner material are orientated in the same direction.

Each of the head portions may be constructed from structural elements of a second type, wherein said structural elements of the second type are non-planar and include a substrate and a liner material in contact with the inner surface of the substrate. In embodiments of the invention, the liner material is adhered to the substrate material by a process of laser cladding.

In certain embodiments, the inner surface of a substrate may be the surface exposed to an interior of a vessel which the substrate forms part of. In further embodiments, the inner surface may be a selected surface of the substrate, in particular when the substrate has two planar surfaces which are interchangeable. In this case the outer surface is the surface opposing the inner surface.

The pressure vessel may be of a generally cylindrical shape over a majority of its length. In an embodiment, the vessel has a length to diameter ration of 10:1 or less. Furthermore, the inner diameter of the vessel may be between 1.5 meters and 3.5 meters. Other sizes—larger or smaller, are also possible. Other shapes such as spherical, optimised spherical and cone-shaped are also possible. In particular, the pressure vessel may have a middle portion having a non-linear axis of symmetry.

The metal substrate may be composed of a material, or combination of materials, selected from the group comprising: carbon steel, carbon steel alloys or other high-strength metals suitable to reduce the structural thickness and therefore the weight to a minimum.

The liner material may be substantially chemically inert once it has been adhered to the substrate material and may have a corrosion resistance of at least that of stainless steel, in relation to hydrocarbons or CNG, and impurities in such fluids, such as H₂S and CO₂.

The liner, or cladding, material may be a metal and may be composed of a material, or combination of materials, selected from the group comprising: stainless steel, stainless steel alloys, aluminium, aluminium-based alloys, nickel, nickel-based alloys, titanium or titanium-based alloys. The liner material of the structural elements of the first type may be the same as, or different from, the liner material of structural elements of the second type.

A further aspect of the invention relates to preparing a pressure vessel for transport or storage of CNG, the pressure vessel comprising a cylindrical wall having an inner metal surface, the method comprising:
providing a liner material;
providing an energy source to melt the liner material in a controlled manner;
positioning the substrate material and moving the energy source so that melted liner material adheres to and covers the cylindrical wall of the pressure vessel;
wherein
the energy source is moved in a linear direction substantially parallel to a longitudinal axis of the pressure vessel.

Preferably, the energy source is a laser. Lasers have the advantage of being smaller and lighter than other energy sources. Advantageously therefore, the method may include moving the energy source while keeping the pressure vessel still.

Alternatively, the energy source may be moved in a linear manner while the pressure vessel is rotated. This is a particularly efficient manner of providing a cladding as the shape of the pressure vessel lends itself to rotation and only a simplified driving mechanism for the laser or other energy source need be provided.

Such methods are useful for repurposing pressure vessels for the storage and transport of CNG.

### Advantages of Embodiments of the Invention

The method according to an aspect of the present invention may provide for pressure vessels which are resistant to corrosion, particularly when transporting and storing CNG.

Moreover, the method according to a further aspect of the present invention may allow less plastic material to be used for the pressure vessel, whilst maintaining its resistance to corrosion.

### BRIEF DESCRIPTION OF THE DRAWINGS

FIG. 1 is a process diagram illustrating the process for producing a cladded pressure vessel;

FIG. 2 is a schematic diagram of the preparation of a structural element of a first type for a pressure vessel;

FIG. 3 is a schematic diagram of the structural element of the first type of FIG. 2 undergoing a bending process;

FIG. 4 is a cross-section of the structural element of FIG. 3;

FIG. 5 is a schematic diagram of the structural element of the first type of FIG. 2 in a completed state;

FIG. 6 is a schematic diagram of a substrate used in the preparation of a structural element of a second type;

FIG. 7 is a schematic diagram of the substrate of FIG. 6 which has undergone moulding;

FIG. 8 is a schematic diagram of the preparation of a pressure vessel;

FIG. 9 is a schematic diagram of a pressure vessel and cladding apparatus for preparation according to an embodiment;

FIG. 10 is a process diagram of a method of preparing a pressure vessel according to an embodiment of the invention; and

FIG. 11 is a schematic diagram of a pressure vessel prepared according to the process illustrated in FIG. 10.

### DETAILED DESCRIPTION OF THE INVENTION

Embodiments of the invention extend to a method of manufacturing pressure vessels, and to the preparation of pressure vessels to render them suitable, or more suitable, for either or both the transportation or storage of CNG.

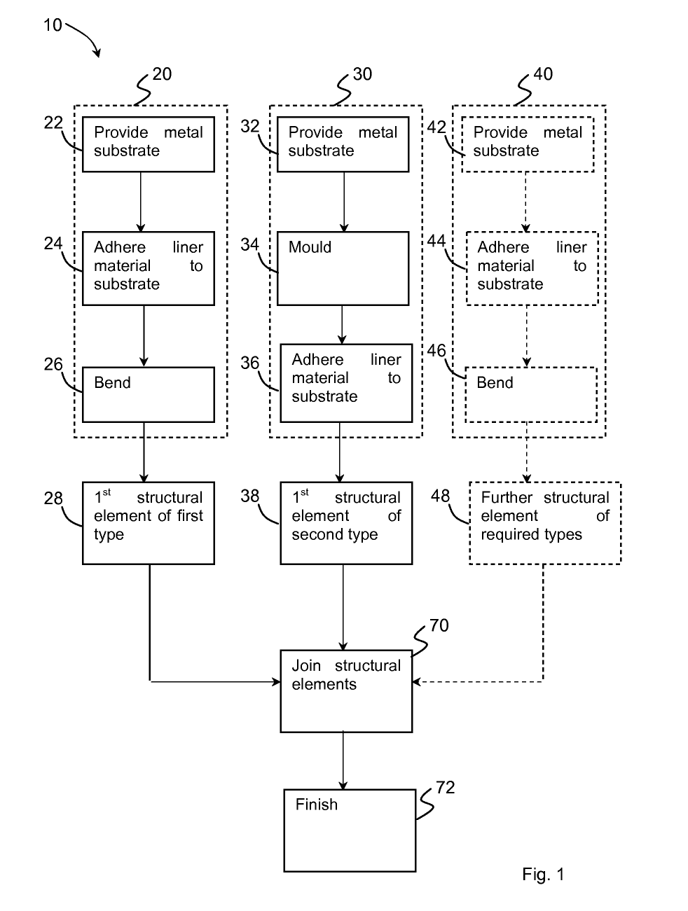

FIG. 1 is a process diagram illustrating the process for producing a cladded pressure vessel. Pressure vessels according to this embodiment have a rounded cylindrical, or cigar, shape comprising a middle cylindrical portion having two dome-shaped ends. In this embodiment, the pressure vessel in comprised of structural elements of two types: structural elements of the first type comprise bent planer elements which form the cylindrical portion and formed shaped portions which form either end.

FIG. 1 illustrates the process 10 for forming pressure vessels according to an embodiment of the invention. The process 10 is divided into two main branches: process branch 20 and process branch 30. Process branch 20 is concerned with the production of structural elements of the first type, and process branch 30 is concerned with the production of structural elements of the second type.

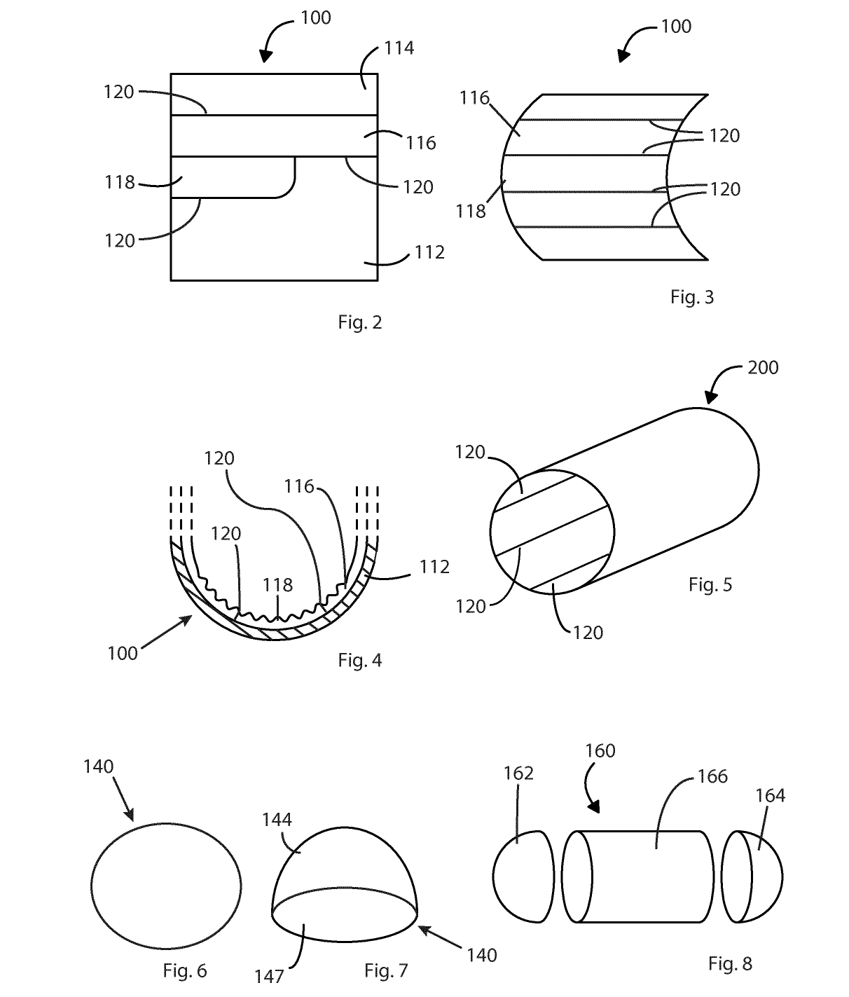

The process branch 20 comprises providing a metal substrate. In this embodiment, the metal substrate is provided as a planar element. In the following step, step 24, a liner material is adhered to the substrate by laser cladding. The manner in which this is done is described in greater detail below with reference to FIG. 2. At the final step of this branch, step 26, the substrate, now covered in liner material, is bent into shape and welded. In this embodiment, the planar member is bent to form a tube, as described below with reference to FIGS. 4 and 5.

In the process branch 30 structural elements of the second type are produced. In the first step, step 32 of this branch, a metal substrate is provided. The shape of this substrate is such that it can be moulded to form a dome, as described in greater detail below with reference to FIGS. 6 and 7. The substrate is then moulded into shape in step 34 and, lastly for branch 30, at step 36 a liner material is then adhered to the metal substrate. The manner in which this may be done is described below with reference to FIGS. 6 and 7.

At step 70, the structural elements which were formed in branches 20 and 30 are joined together to form a pressure vessel. In this embodiment, the pressure vessel (as shown in FIG. 7) comprises a single middle cylindrical portion with two dome-shaped head portions attached thereto. Therefore, in this embodiment, step 70 comprises taking a single cylindrical structural element formed by branch 20 and two dome structural elements formed by branch 30 and welding them together to form a pressure vessel.

It is to be realised however that pressure vessels according to embodiments of the invention are not limited by the number and formation of the structural elements which may be used for the pressure vessel. For example, in further embodiments, two or more cylindrical portions are arranged co-axially and joined to produce a longer pressure vessel. In further embodiments additional components such as manholes and covers are incorporated into the pressure vessel. For each additional structural element required, the process 10 will include additional branches. One of these, branch 40, is illustrated in dashed outline in FIG. 1. Branch 40 comprises a step 42 of providing a metal substrate, step 44 of adhering a liner to the metal substrate and step 46 of bending and welding the substrate. This branch 40 is suitable for manufacturing additional cylindrical structural elements to incorporate into the pressure vessel. Where other components are needed, the steps of the additional branch or branches may be adapted accordingly. All such components are joined together in step 70.

Finally, at step 72 any required finishing such as cleaning and polishing is applied to the completed pressure vessel.

In this embodiment, high-strength carbon steel is used for the substrate and a stainless steel (316L or similar) or nickel alloy (825 or similar) is used as the liner material. It is to be realised however that there are many materials which may form the substrate and the liner material. The metal substrate may, for example be composed of a material, or combination of materials, selected from the group comprising: carbon steel, carbon steel alloys or other high-strength metals suitable to reduce the structural thickness and therefore the weight to a minimum. The liner metal may, for example, be composed of a material, or combination of materials, selected from the group comprising: stainless steel, stainless steel alloys, aluminium, aluminium-based alloys, nickel, nickel-based alloys, titanium or titanium-based alloys. Other materials, and combinations of materials, for the substrate and the liner are also possible.

The manner in which the various steps of the process 10 may be carried out are illustrated in FIGS. 2 to 8. FIG. 2 illustrates the preparation of a structural element 100 comprising a substrate 112 which is covered by a liner material of a first type for a pressure vessel. This Figure illustrates a substrate 112 over which adjoining linear areas of liner material 114, 116 and 118 have been adhered. In this embodiment, the adjoining linear areas of lining material 114, 116 and 118 have been applied using a process of laser cladding. This is a sequential process and therefore, the linear area 114 was applied first, then the linear area 116. FIG. 2 illustrates the structural element as the linear area 118 is in the process of being applied in the direction from left to right. Therefore, the linear area 118 is partially formed.

As each linear area is applied, the laser cladding is controlled so that the material of a subsequent linear area overlaps the previous linear area thereby forming a join 120 located along the direction of application of the linear area of liner material (cladding). With reference to FIG. 1, the process illustrated in FIG. 2 is the process of step 24.

FIG. 3 illustrates the structural element of FIG. 2 in the process of being bent. This represents a portion of step 26 of the process 10 of FIG. 1. As illustrated in FIG. 3, the structural element 100 is bent in a direction so that the bending occurs in a direction parallel to the orientation of adjoining linear areas of liner material, 114, 116 and 118, as well as the remaining linear areas illustrated in this figure which have not been allocated reference numerals. As further illustrated, this bending also occurs parallel to lines 120 formed by overlapping adjoining linear areas of liner material.

FIG. 4 is a cross-section of the structural element 100 illustrated in FIG. 3. As illustrated in this Figure, the bending of the structural element 100 causes a crimping effect in the liner material 116 and 118 (and in the other linear areas of this liner material). This crimping effect has been exaggerated in FIG. 4; the actual undulations in the surface caused by the bending would be smaller and less pronounced than illustrated. The crimping has the effect of tending to cause closure or reduction in pores formed in the surface of the liner material. This, in turn, renders the liner material less susceptible to corrosion and therefore pressure vessels prepared using processes and structural elements according to embodiments of the invention are particularly suitable for transporting CNG and other potentially corrosive substances.

FIG. 5 illustrates the structural element 100 when formed into a complete structural element for a pressure vessel. As shown, the structural element forms a cylindrical structural element when two sides are welded together to form the cylinder. The formation of a cylinder also defines a inner and outer surface for the substrate, the inner surface being that surface facing the inside of the cylinder and the outer surface being the opposing surface. As illustrated, the liner material has been applied to that surface which is the inner surface.

FIG. 6 illustrates a substrate 140 used in the construction of structural elements of a second type. These structural elements of the second type correspond to the dome ends of the pressure vessel constructed according to branch 30 of the process 10 of FIG. 1. The substrate 140 has is round and is formed into a dome by a process of stamping. FIG. 7 illustrates the substrate 140 after it has been stamped into a dome, corresponding to step 34 of the process 10 of FIG. 1, thereby forming a dome structural element. The substrate 140 illustrated in FIG. 7 has had an inner surface which faces the interior of the dome, the opposing surface being an outer surface.

The inner surface of the substrate 140 is covered by adjoining linear areas of liner material, here shown as strips 142, 144 and 146 illustrated by dashed lines as the strips are only visible from the interior of the dome. This corresponds to step 36 of the process 10 of FIG. 1.

FIG. 8 illustrates a pressure vessel 160 in exploded view. The pressure vessel comprises a first head section 162, a second head section 164 and a middle section 166. The two head sections 162 and 164 correspond to the dome structural elements formed by branch 30 of process 10 of FIG. 1 as described above with further reference to FIGS. 6 and 7. The middle section corresponds to the cylindrical structural element 100 formed by the branch 20 of process 10 of FIG. 1 as described above with further reference to FIGS. 2 to 5. The head section 162 is attached to one end of the cylindrical middle portion 166 and the other head section 164 is attached to the other end of the cylindrical middle portion 166. All these attachments occur by welding. The resultant pressure vessel is particularly well suited to the storage and/or transport of CNG and other corrosive substances under pressure.

Such constructions also allow the pressure vessel to be able to carry a variety of gases, such as raw gas straight from a bore well, including raw natural gas, e.g. when compressed—raw CNG or RCNG, or H₂, or CO₂ or processed natural gas (methane), or raw or part processed natural gas, e.g. with CO₂ allowances of up to 14% molar, H₂S allowances of up to 1,000 ppm, or H₂ and CO₂ gas impurities, or other impurities or corrosive species. The preferred use, however, is CNG transportation, be that raw CNG, part processed CNG or clean CNG—processed to a standard deliverable to the end user, e.g. commercial, industrial or residential.

CNG can include various potential component parts in a variable mixture of ratios, some in their gas phase and others in a liquid phase, or a mix of both. Those component parts will typically comprise one or more of the following compounds: C₂H₆, C₃H₈, C₄H₁₀, C₅H₁₂, C₆H₁₄, C₇H₁₆, C₈H₁₈, C₉+ hydrocarbons, CO₂ and H₂S, plus potentially toluene, diesel and octane in a liquid state, and other impurities/species.

It is to be realised that the pressure vessel may be constructed from further or alternate structural elements than those illustrated here. In particular, the pressure vessel would additional include an inlet and a neck portion, each of which may be formed by a metal substrate having a liner material adhered to the inner surface in adjoining linear areas.

The domed head portions of the cylinder may alternatively be manufactured using a process of “spin forming” whereby a disc of substrate and liner material is shaped to the desired shape whilst being spun about an axis of rotation. This is applicable where the thickness of the substrate allows such spin formation.

Similarly, the middle section may be formed from further structural elements joined to one another. In a simple configuration, the middle section of the pressure vessel is formed from two cylindrical portions, each formed according to the branch 20 of the process 10 of FIG. 1 joined end-to-end to create an elongate pressure vessel (when compared to the vessel 160 illustrated in FIG. 8).

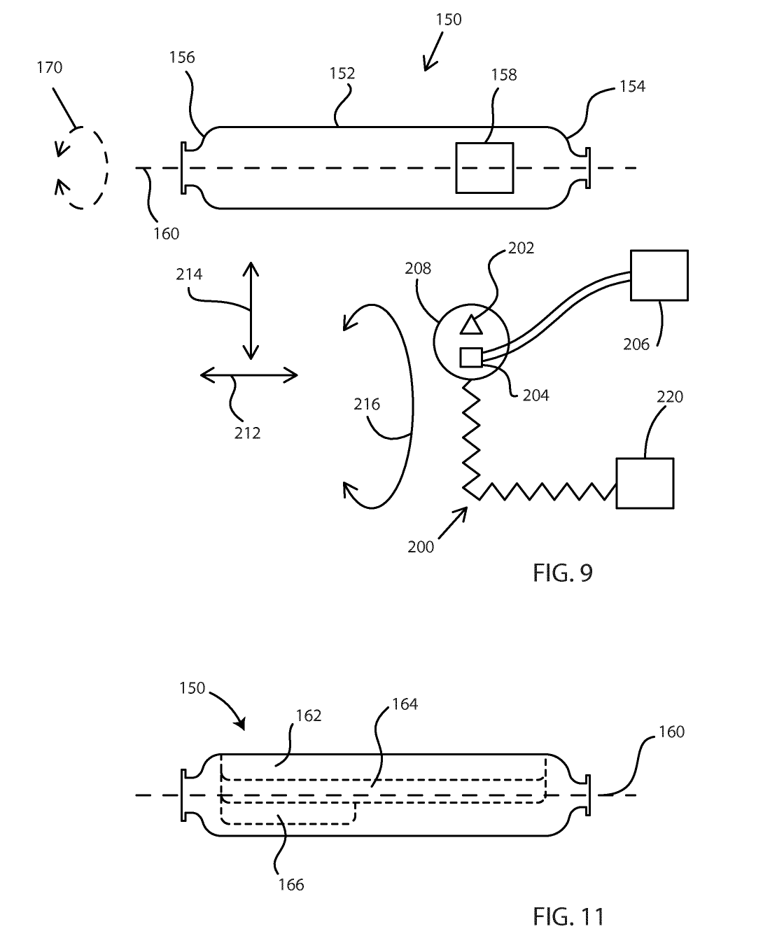

FIG. 9 is a schematic diagram of a pressure vessel 150 and cladding apparatus 200 suitable for preparing the pressure vessel for the storage and/or transport of CNG according to an embodiment of the invention. The pressure vessel 150 is of any known type having a metal wall, or an inner surface which is metal and which is suitable for cladding. In this embodiment, the pressure vessel 150 includes a central cylindrical portion 152 and two head portions 154 and 156.

The cladding apparatus 200 comprises a laser 202 generating a laser beam and a nozzle 204 providing the liner material. The nozzle 204 is connected to a source 206 of liner material preferably provided in the form of powder. The laser 202 and nozzle 204 are attached to a head 208 which is, in turn, mounted to an articulating and rotating arm 210. The arm 210 is connected to a driving mechanism 220 which, in the embodiment illustrated, is able to move the arm 210 such that the head 208 moves horizontally in the direction of arrows 212, vertically in the direction of arrows 214 and is able to move in a direction perpendicular to both arrows 212 and 214 (in and out of the plane of the paper of FIG. 9). In addition, the driving mechanism and arm act together to rotate the head 208 in the direction of arrows 216.

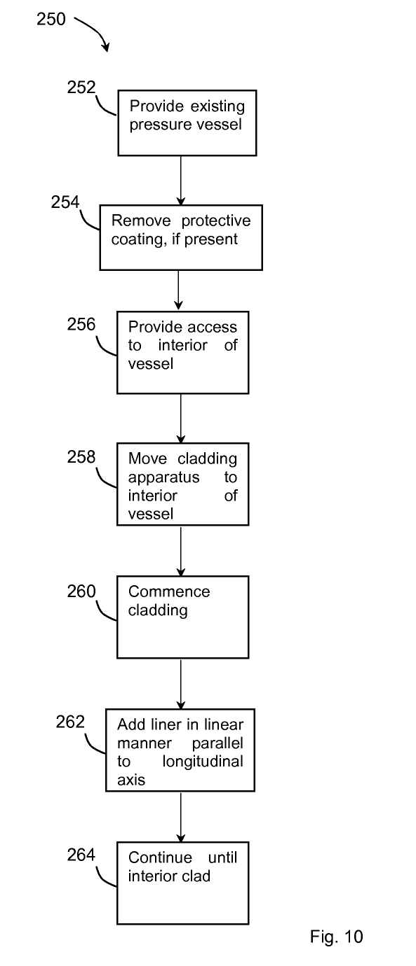

FIG. 10 is a process diagram of a method 250 of preparing a pressure vessel for the transport and/or storage of CNG according to an embodiment of the invention. In an initial step, step 252, a pre-existing pressure vessel is provided. In the illustration of FIG. 9, this is the pressure vessel 150. Many different types of pressure vessels are suitable with use of the process illustrated in FIG. 10 provided that they have, or could be provided with, an internal metal surface suitable for cladding. Furthermore, any existing polymeric coatings or surface treatments/protections will be removed, in step 254, before the cladding process begins.

In the following step, step 256, access for the cladding apparatus such as cladding apparatus 200 of FIG. 9 to the interior of the pressure vessel is provided. The manner in which this step is carried out will depend on the type and size of the pressure vessel concerned. In the pressure vessel of FIG. 9, access to the interior of this pressure vessel is provided by cutting a port 158 into a side wall of the pressure vessel. However, alternate pressure vessels may be provided with one or more manholes which are sized to allow access of the cladding apparatus to the interior of the pressure vessel.

Referring back to FIG. 10, in the following step, step 258, the cladding apparatus is introduced into the interior of the pressure vessel. With the cladding apparatus 200 of FIG. 9 this occurs by having the driving mechanism 220 drive the arm 210 to cause the head 208 with nozzle 204 and laser 202 to move into the interior of the pressure vessel 150. A cladding process will then commence at step 260. Again, with reference to the apparatus of FIG. 9, this involves the expulsion of liner material from the nozzle 204 and simultaneous melting of this material in a controlled fashion by the laser. The general characteristics of cladding processes are known and will not be further described herein.

Importantly for certain embodiments of the invention however, in step 262, the head is moved in a linear manner in a direction parallel to the longitudinal axis of the pressure vessel (160 for the pressure vessel 150 of FIG. 9). In this manner, the cladding or liner material deposited by the cladding apparatus will be deposited and will adhere to the interior surface of the pressure vessel in a linear strip. Referring back to the pressure vessel 150 of FIG. 9, the cladding is applied to the cylindrical portion 152 of the pressure vessel 150 first. For this portion, the cladding apparatus will move and apply the cladding in substantial linear, partially overlapping linear bands running parallel to the longitudinal axis 160 of the pressure vessel 150.

In further embodiments, the area over which the cladding material is to be laid has a non-linear axis of symmetry. For example, the end portions, or a non-cylindrical pressure vessel will have portions with non-linear axes of symmetry. In such cases, the head moves parallel to the axis of symmetry, i.e. parallel to the inner surface of the wall of the vessel.

By depositing and adhering the liner material to the interior of the pressure vessel in adjoining linear areas or bands, embodiments of the invention help to ensure that pressure vessels prepared in this manner are less susceptible to corrosion than those prepared in other manners. Generally, the weaker part of a cladded structure is the portion having a thinner cladding thickness, or the area between two cladded portions. However, applying the cladding material in overlapping bands tends to minimize the part of the cladding exposed to the corrosive action of the material stored in the pressure vessel.

The process will continue until the interior surface of the pressure vessel has been clad (step 264 of FIG. 10). How this occurs will depend on the size and shape of the pressure vessel. For many pressure vessels such as the pressure vessel 150 of FIG. 1, and for a pressure vessel having the shape of pressure vessel 60 of FIG. 7, the cladding occurs in two distinct steps. In the first step the cylindrical portion of the pressure vessel is clad in adjoining linear areas or bands. In a second step, the head portions of the pressure vessel are clad. Once the cladding process is completed, the port 158 will be again sealed.

FIG. 11 is a schematic diagram of the pressure vessel 150 illustrated in FIG. 9 whilst being prepared according to the process illustrated in FIG. 10. As illustrated, the pressure vessel 150 has bands of liner material, or cladding, 162, 164 and 166 which have been applied to an inner surface of the pressure vessel. The pressure vessel 150 is here illustrated during deposition of the band 166 and this band is therefore partially formed. As illustrated, the bands 162, 164 and 166 lie parallel to a longitudinal axis 160 of the pressure vessel 150.

In the embodiment illustrated in FIGS. 9 to 11 and described above, the cladding apparatus is moved relative to the pressure vessel to apply the desired cladding to the inside surface of the pressure vessel. However, such an arrangement suffers from the disadvantage that the driving mechanism 220 driving the arm 210 on which the laser and nozzle are mounted need to be relative complex, having relatively large number of degrees of freedom of movement. In an alternate arrangement, the driving mechanism controls lateral movement of the laser 202 and the nozzle 204, and the pressure vessel is rotated in the direction illustrated by dashed arrow 170 of FIG. 9. This has the advantage that many pressure vessels to be prepared for CNG transport and/or storage have rotational symmetry which lends itself to relatively efficient rotational movement.

Although embodiments of the invention have been described with reference to cylindrical pressure vessels, it is to be realised that other embodiments are equally applicable to pressure vessels with other shapes. For example, embodiments of the invention may be equally applied to pressure vessels having round (spherical) or optimised spherical shapes (such as those described and illustrated in PCT/EP2011/071786), as well as those with a cone-shaped section (such as those described in PCT/EP2011/071801

Other pressure vessels which may be constructed or prepared according to embodiments of the invention are disclosed in PCT/EP2011/071782, PCT/EP2011/071797, PCT/EP2011/071793, PCT/EP2011/071794, PCT/EP2011/071799, PCT/EP2011/071786, PCT/EP2011/071805, PCT/EP2011/071810, PCT/EP2011/071815, PCT/EP2011/071813, PCT/EP2011/071812, PCT/EP2011/071818, PCT/EP2011/071807, PCT/EP2011/071801, PCT/EP2011/071817, and PCT/EP2011/071791. In each case they will only be suitable where the relevant element of the pressure vessel, e.g. the liner, or layer or layers, or parts thereof, are both metal and structural, rather than non-metalic or non-structural. The entire contents of these additional cases are incorporated herein by way of reference, along with the other already mentioned cases. These contents additionally set out various advantageous uses or modifications for the pressure vessels of the present invention, including various ways in which they might be used, manufactured or modified or how they might be used or installed in a ship, carrier or other transport device.

Preferably where a pressure vessel has been prepared according to the process of the invention, the resulting pressure vessel will have an internal wall or surface that is substantially inert relative to the fuel or natural gas it is intended to store or transport. The inner wall of the pressure vessel will tend not to corrode when in contact with the fuel to be stored or transported. In certain embodiments, to be deemed substantially inert relative to the fuel to be stored or transported, the cladded wall may have corrosion resistance properties relative to the fuel to be stored or transported of at least an AISI 316 stainless steel. This may be used as reference point for determine corrosion resistance, regardless of whether that particular material is used for the cladding.

For example, this degree of corrosion resistance may be determined relative to one or more of the anticipated contaminates therein, one such contaminate being the expected level of typically aggressive compounds such as H₂S, e.g. in the presence of H₂O. Another mode of determining whether the material is deemed to be substantially inert relative to the fuel to be stored or transported it to determine whether the material, or internal wall, is essentially H₂S resistant, i.e. substantially H₂S resistant, or preferably H₂S resistant. One approach for determining this is to determine whether it is in accordance with ISO15156.

No doubt many other effective alternatives will occur to the skilled person. It will be understood that the invention is not limited to the described embodiments and encompasses modifications apparent to those skilled in the art lying within the spirit and scope of the claims appended hereto.

1. A method of producing a pressure vessel, the method comprising:
providing a first metal substrate having an outer surface and an inner surface;
producing one or more structural elements of a first type for the pressure vessel by adhering a liner material to said substrate; and
joining a plurality of structural elements to form said pressure vessel, wherein:
said step of producing said structural elements of the first type includes adhering the liner material to the inner surface of the first metal substrate in adjoining linear areas; and
said step of joining the plurality of structural elements includes orientating said structural elements of the first type so that the adjoining linear areas of lining material are orientated longitudinally with respect to a completed pressure vessel.

2. The method according to claim 1 wherein structural elements of the first type are provided as substantially planar members.

3. The method according to claim 1 or claim 2 further comprising deforming one or more of said structural elements of the first type.

4. The method according to claim 3 wherein the deformation comprises bending.

5. The method according to claim 4 wherein the structural element of the first type is orientated so that the bending occurs in a direction parallel to the orientation of said adjoining linear areas of liner material.

6. The method according to claim 4 or claim 5 wherein the bending causes the liner material to crimp.

7. The method according to any preceding claim wherein the liner material is substantially chemically inert once it has been adhered to the substrate material.

8. The method according to any preceding claim wherein the pressure vessel is comprised of two head portions attached to either end of a cylindrical portion.

9. The method according to claim 8 wherein the cylindrical portion is constructed from one or more structural elements of the first type.

10. The method according to claim 8 or claim 9 wherein all structural elements of the first type for the cylindrical portion are orientated so that the linear areas of liner material are orientated in the same direction.

11. The method according to any of claims 8 to 10 wherein each of the head portions is constructed from structural elements of a second type, wherein said structural elements of the second type are non-planar and include a second metal substrate and a liner material in contact with the inner surface of the substrate.

12. The method according to any of claims 8 to 11 wherein the pressure vessel is of a generally cylindrical shape over a majority of its length.

13. The method according to claim 12 wherein the vessel has a length to diameter ration of 10:1 or less.

14. The method according to claim 12 or claim 13 wherein the inner diameter of the vessel is between 1.5 meters and 3.5 meters.

15. The method according to any preceding claim wherein the first or the second metal substrate is composed of a material, or combination of materials, selected from the group comprising: carbon steel, carbon steel alloys or other high-strength metals suitable to reduce the structural thickness and therefore the weight to a minimum.

16. The method according to any preceding claim wherein the liner material has a corrosion resistance of at least that of stainless steel, in relation to hydrocarbons or CNG, and impurities in such fluids, such as H₂S and CO₂.

17. The method according to any preceding claim wherein the liner metal is composed of a material, or combination of materials, selected from the group comprising: stainless steel, stainless steel alloys, aluminium, aluminium-based alloys, nickel, nickel-based alloys, titanium or titanium-based alloys.

18. The method according to any preceding claim wherein the liner material is adhered to the substrate material by a process of laser cladding.

19. A method of preparing a pressure vessel for transport or storage of CNG, the pressure vessel comprising a cylindrical wall having an inner metal surface, the method comprising:
providing a liner material;
providing an energy source to melt the liner material in a controlled manner;
positioning the substrate material and moving the energy source so that melted liner material adheres to and covers the cylindrical wall of the pressure vessel;
wherein the energy source is moved in a linear direction substantially parallel to a longitudinal axis of the pressure vessel.

20. The method according to claim 19 wherein the energy source is a laser.

21. The method according to claim 19 or claim 20 further comprising moving the energy source while keeping the pressure vessel still.

22. The method according to claim 19 or claim 20 further comprising moving the energy source in a linear manner while the pressure vessel is rotated.

23. A pressure vessel for storage and/or transport of CNG, the pressure vessel having an elongate, central, substantially cylindrical portion and two head portions attached to either end of the cylindrical portion, the cylindrical portion comprising a metal substrate clad with a liner material wherein the liner material is arranged on said substrate in adjoining elongate linear areas which are orientated substantially parallel to a longitudinal axis of said pressure vessel.
